(19) United States
(12) Patent Application Publication
(10) Pub. No.: US 2018/0239049 A1
(43) Pub. Date: Aug. 23, 2018

(54) ELECTROMAGNETIC INVERSION MODEL REDUCTION

(71) Applicant: PGS Geophysical AS, Oslo (NO)

(72) Inventor: Johan Mattsson, Trångsund (SE)

(21) Appl. No.: 15/902,061

(22) Filed: Feb. 22, 2018

Related U.S. Application Data
(60) Provisional application No. 62/462,535, filed on Feb. 23, 2017.

(51) Int. Cl. G01V 3/36; G01V 3/17; G01V 3/08

(52) U.S. Cl. CPC G01V 3/36; G01V 2003/086; G01V 3/083; G01V 3/17

(57) ABSTRACT

Various methods for performing inversion of data obtained from a CSEM survey in order to determine resistivity values in a surveyed space are disclosed. A method includes initializing an objective functional dependent measured and modeled electric field data and iteratively minimizing the objective functional to produce an estimated set of expansion coefficients for generating a multi-dimensional record of resistivity values. The set of expansion coefficients is dependent on a resistivity model, which in turn is used to generate an electric field model in the form of a multi-dimensional grid having a number of grid points. Thus, instead of performing the inversion for each point in the grid, the record of resistivity values is generated based on the set of coefficients. The number of coefficients may be at least one decimal order of magnitude less than the number of grid points, and thus the computational effort is reduced.

### PRIORITY CLAIM

This application claims benefit of priority of U.S. Provisional Appl. No. 62/462,535, filed Feb. 23, 2017, which is hereby incorporated by reference in its entirety.

### BACKGROUND

### Description of the Related Art

Marine geophysical surveying is a technique for investigating geological features underneath bodies of water. Various types of signal sources and geophysical sensors may be used in different types of geophysical surveys. Electromagnetic (“EM”) geophysical surveys, as an example, are based on the use of electromagnetic waves. In conducting an EM geophysical survey, a survey vessel tows one or more sources (e.g., for a controlled-source electromagnetic (CSEM) survey) and one or more streamers. A number of sensors (e.g. electromagnetic sensors) are located along each of the streamers.

During the course of a geophysical survey, the various sensors may collect data indicative of geological structures. According to a conventional approach, an inversion procedure may be performed on such data to determine resistivity values at various points in a multi-dimensional grid that is representative of the surveyed space. In particular, the inversion may be performed for each of the points in the multi-dimensional grid to determine the resistivity at each. Such a procedure can be quite computationally expensive due to the multiplicity of points at which the inversion is to be performed.

### BRIEF DESCRIPTION OF THE DRAWINGS

FIG. 1 is a diagram illustrating one embodiment of a configuration for performing a controlled-source electromagnetic (CSEM) survey.

FIG. 2 is an illustration of one embodiment of a multi-dimensional grid used in modeling an electromagnetic field.

FIG. 3 is a flow diagram illustrating one embodiment of a method for performing an inversion of data collected during a CSEM survey.

FIG. 4 is a flow diagram illustrating another embodiment of a method for performing an inversion of data collected during a CSEM survey.

FIG. 5 is a flow diagram illustrating another embodiment of a method for performing an inversion of data collected during a CSEM survey.

FIG. 6 is a block diagram of one embodiment of a processing apparatus for determining resistivity values based on CSEM survey data.

FIG. 7 is a block diagram of one embodiment of a computer system.

While the disclosure is susceptible to various modifications and alternative forms, specific embodiments thereof are shown by way of example in the drawings and are herein described in detail. It should be understood, however, that the drawings and detailed description thereto are not intended to limit the disclosure to the particular form disclosed, but on the contrary, the intention is to cover all modifications, equivalents and alternatives falling within the spirit and scope of the present disclosure, including the appended claims. Particular features, structures, or characteristics may be combined in any suitable manner consistent with this disclosure.

It is to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The terms “include,” “comprising,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to generate a hash value” is intended to cover, for example, a mobile device that performs this function during operation, even if the device in question is not currently being used (e.g., when its battery is not connected). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be considered to be configured to perform that function.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

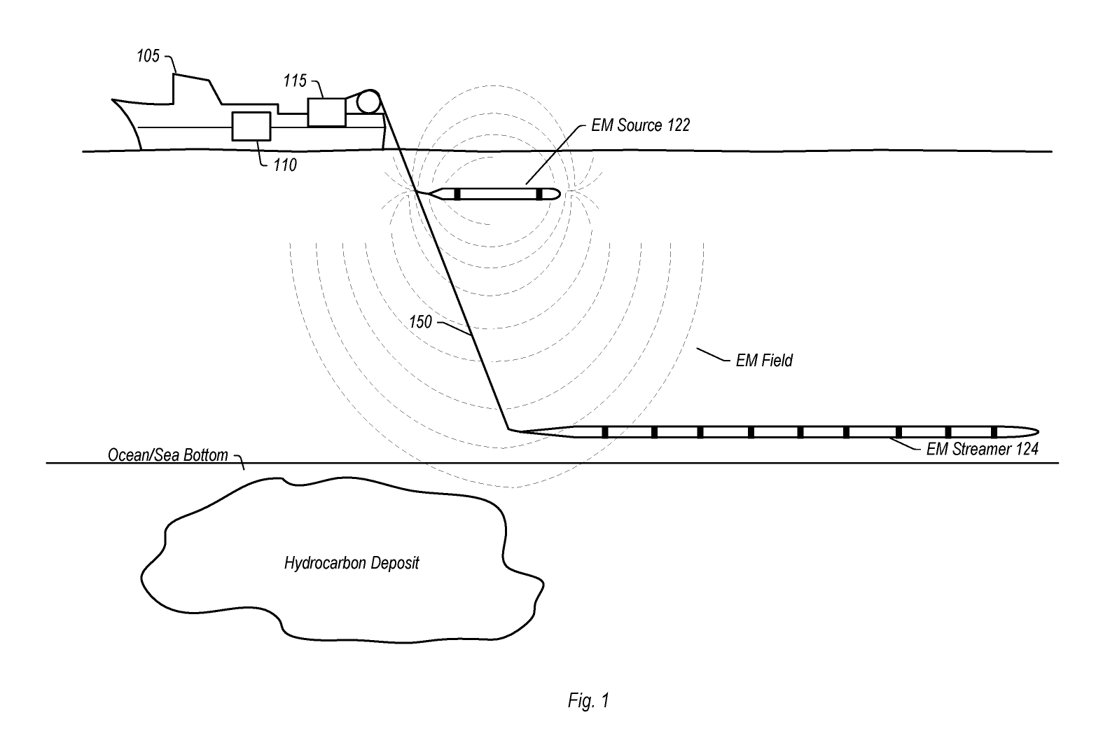

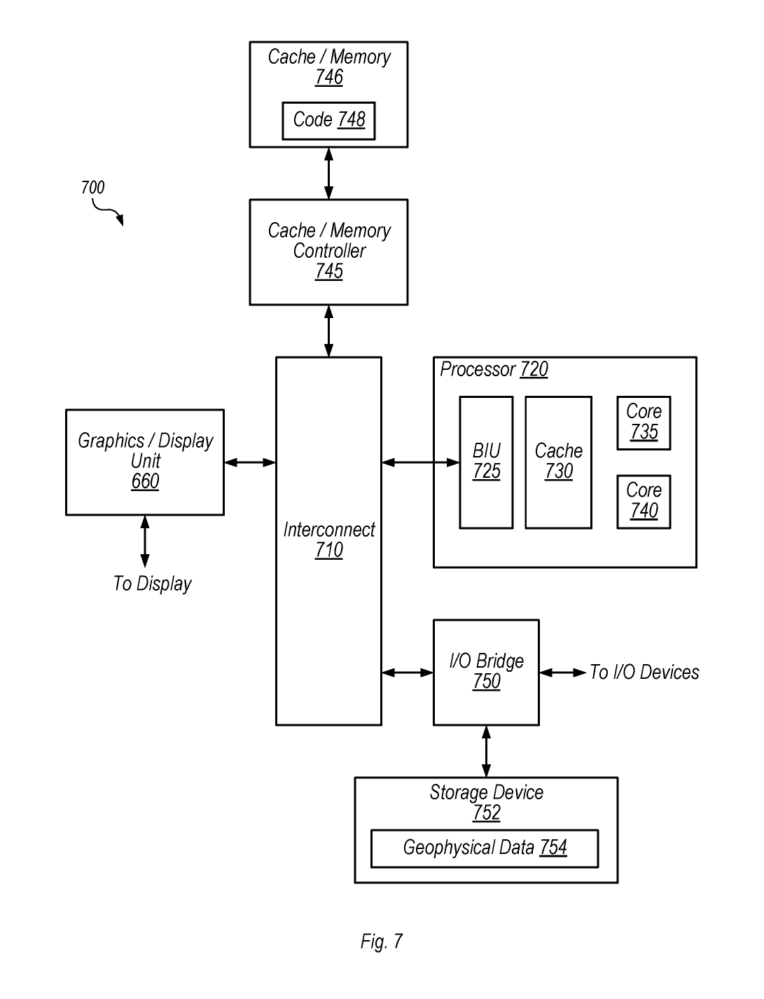

This disclosure initially describes, with reference to FIG. 1, an overview of a geophysical survey system. It then describes example techniques for processing data that may be acquired by a geophysical survey. Finally, an example computing system is described with reference to FIG. 7.

### Survey Overview

Turning now to FIG. 1, a tow vessel towing sub-sea equipment for conducting a controlled source electromagnetic (CSEM) survey is shown. The configuration shown here may be used for various types of surveys, such as those used in the exploration for hydrocarbon deposits. In the embodiment shown, a tow vessel 105 on the surface of a body of water (e.g., an ocean, a sea, etc.) is towing sub-sea EM source 122 and sub-sea EM streamer 124 in order to conduct a sub-sea EM survey. Sub-sea source 200 in the embodiment shown is coupled to tow vessel 105 via a tow cable 150. Tow vessel 105 includes a transformer 115, which is coupled to receive power from a ship's power source 110. Transformer 115 may in turn provide a transformed voltage to tow cable 150, and thus to EM source 122.

EM source 122 in the embodiment shown may generate an EM field via a source signal output therefrom. Various types of source signals may be used, and may include sinusoidal waves at various frequencies. The resulting EM field may be measured along EM streamer 124, e.g., as electric potential differences in distributed electrode pairs along the streamer. Data collected from the CSEM survey may be used to determine the presence of distortions in the EM field, which in turn may indicate the presence of oil or other hydrocarbon deposits.

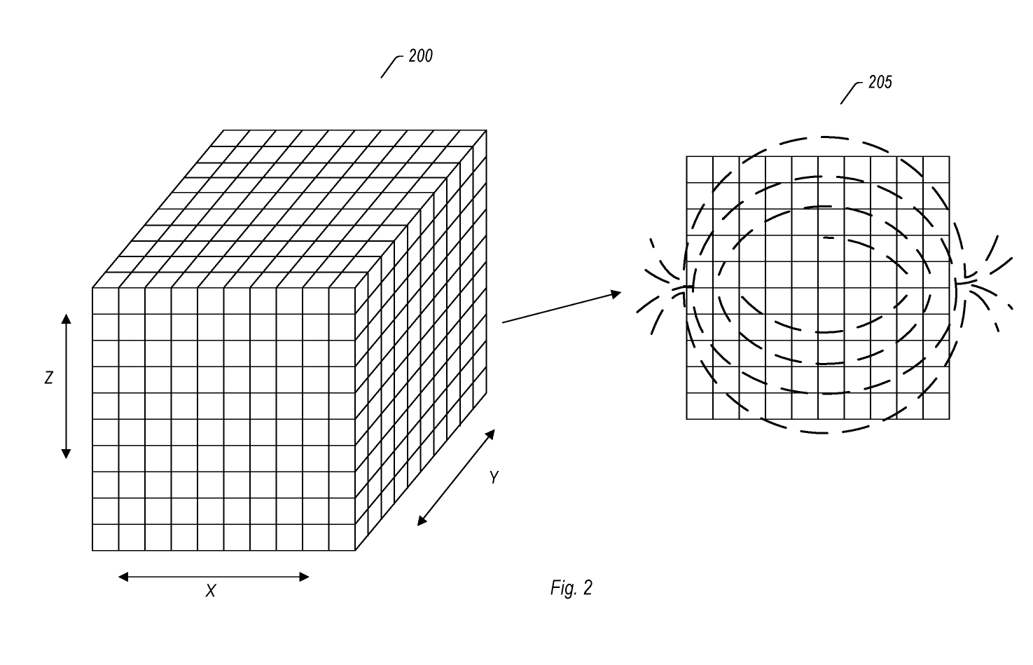

The raw data from the CSEM survey may be conveyed to a collection system on survey vessel 105. Typically, the raw time-series survey data needs further analysis in order to generate a model or image corresponding to the sub-sea structure reveal the estimated locations of geological features of interest. For example, a multidimensional record of resistivity values may be generated from a time-series record of electric field data using a procedure that may be generally referred to as “inversion.” (It is noted that as used herein, a “record” of data refers to a representation of data that is stored or otherwise embodied in a physical medium. Physical media may include, by way of non-limiting example, persistent storage devices such as magnetic, optical, or nonvolatile media, various types of computer system memory, and other types of non-transitory computer-readable media as discussed below.) The amount of data collected may correspond to the volume over which the CSEM survey is conducted. For example, a survey volume on the order of 150×100×4 km³ is possible and contemplated. For such large volumes, the amount of data may be correspondingly large. In order to facilitate inversion, the collected data may be discretized into a number of data points (e.g., in a multi-dimensional grid, as discussed below in reference to FIG. 2) corresponding to horizontal and vertical resistivity values, arranged in a matrix, or grid.

The data points for such a large volume as the example given above can number in the millions. Performing a multi-dimensional inversion to determine the resistivity values at each of the data points in such a large grid may in turn consume a significant amount of computing resources in terms of both the necessary storage and processing (computational) time. The present disclosure contemplates a methodology in which the computing resources required for performing the inversion may be significantly reduced. In various embodiments, the methodology is based on a global mathematical expansion of the sub-surface conductivity (which is the inverse of resistivity) in an appropriate set of basis functions. Instead of inverting for the actual resistivity values at each point of the multi-dimensional grid, inversion is performed for coefficients used in the mathematical expansion. The number of expansion coefficients may be at least one decimal order of magnitude less than the number of grid points, and in some cases, multiple orders of magnitude less. For example, in a data set in which the number of grid points is in the millions, the number of expansion points may be less than ten thousand. As a result, since the number of unknowns is reduced by one or more orders of magnitude, a corresponding reduction in storage capacity and computing time may be realized. Correspondingly, the turnaround time for calculating sub-surface resistivity values and overall cost for performing the same may also be significantly reduced when compared to a methodology in which the inversion is performed for resistivity values at each grid point of the multi-dimensional grid.

The ability to determine a large number of resistivity values by inverting expansion coefficients instead of each individual point is made possible by the following insight. Generally speaking, the conductivity (and thus the resistivity) does not vary dramatically in a sub-surface marine environment in the absence of, e.g., hydrocarbon deposits. Instead, the conductivity/resistivity in the sub-surface marine environment may be characterized by a continuous, well-behaved function. In other words, the individual elements of the inversion grid are not in fact independent from one another, but instead related by virtue of the predictable nature of the measured electric field. As discussed in greater detail below, such a priori knowledge of the measured phenomenon can be employed to solve for a model of the conductivity/resistivity, rather than solving directly for conductivity/resistivity at each discrete point in the grid.

An example of a multi-dimensional grid that is representative of the CSEM survey volume is shown in FIG. 2. It is noted that the grid shown here is presented for the purposes of illustration and is not intended to be limiting in any manner. In the illustrated example, grid 200 is a three-dimensional grid representative of the space over which a CSEM survey has been conducted, is to be conducted, and/or has otherwise been modeled. Grid 200 extends along three axes, X, Y, and Z. A two-dimensional grid 205, shown here with EM field lines, is representative of a two-dimensional portion of grid 200, extending along any two axes, and may be at any point along a third axis. The EM field depicted in FIG. 2 may be a continuous field that extends along each of the three axes shown. Thus, at any point within the grid, such as those represented by intersecting lines, the EM field may be present during a survey. Furthermore, the resistivity/conductivity may be modeled and determined for any of the grid points represented by intersecting lines.

### Various Method Embodiments for the Inversion of Multi-Dimensional CSEM Data

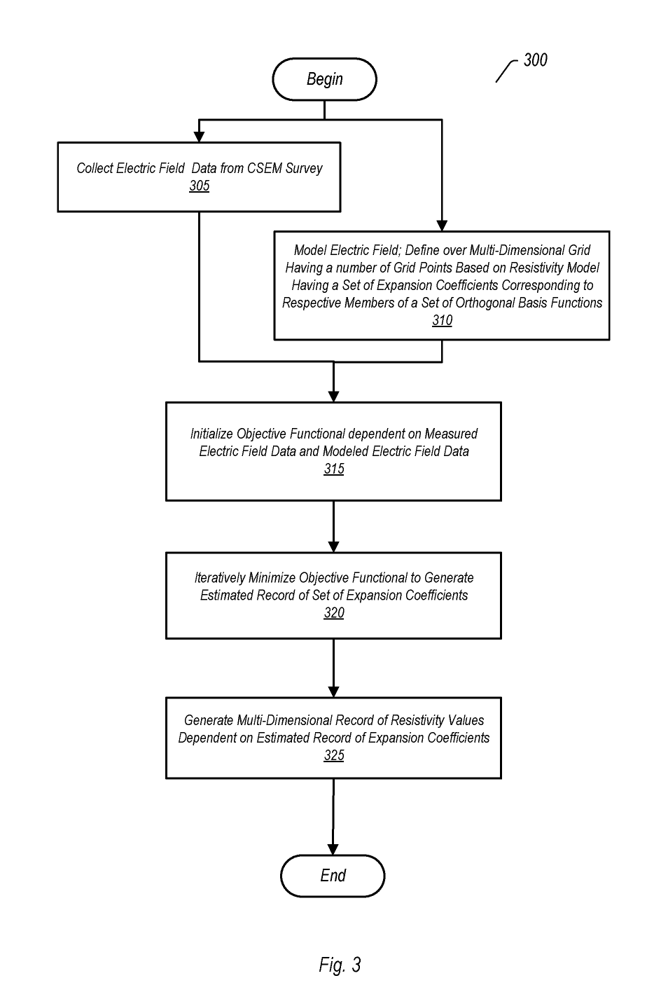

FIGS. 3-5 are flow diagrams illustrating various embodiments of a method for performing an inversion of data collected in a CSEM survey. The discussion of these figures is preceded by a brief discussion of the underlying mathematics of the inversion, which may form a basis for the corresponding method embodiments.

In at least one embodiment, a mathematical expansion of sub-surface conductivity in a set of basis functions may be performed. (Conductivity is the inverse of resistivity. It is noted that any operations described herein as being performed with respect to resistivity may equivalently be performed with respect to conductivity without loss of generality.) Mathematically, the global expansion of the logarithm of the conductivity can be expressed as Equation 1:

G(r)=log₁₀(σ(r))=Σⱼ₌₁^{∞}cⱼBⱼ(r)≈Σⱼ₌₁^{N}cⱼBⱼ(r) (1),

where the infinite series is truncated to include N terms for practical computational results. The vector r can denote the spatial position in the sub-surface (e.g., within the grid discussed above), while Bⱼ(r) is a suitable set of basis functions. The basis functions may be orthogonal basis functions, and may include b-splines, wavelets, curvelets, or any combination of those listed here. Furthermore, per Equation 1, the basis functions correspond to a logarithm of the conductivity. While conductivity may be modeled directly in some embodiments, modeling the logarithm of conductivity may produce a formulation that in some instances is better behaved during subsequent processing (e.g., is less likely to produce sharp inflections that may complicate the minimization process discussed below).

Inversion of CSEM survey data can be formulated as a minimization (e.g., a Gauss-Newton minimization). In one embodiment, the minimization can be expressed with the following objective functional as Equation 2:

P(m)=∥W_{d}(E(m)−d)∥_{L}_{₂}²+αR(m) (2),

where m=[c₁, c₂, . . . c_{N}] represents the expansion coefficients as expressed in Equation 1, E(m) represents a modeled electric field, d represents a measured electric field, R(m) represents a regularization functional applied to the set of expansion coefficients, α represents a regularization parameter, and W_{d} represents a data weight matrix.

In one embodiment, the objective functional as represented by Equation 2 can be minimized using an iterative Gauss-Newton function. Minimizing the objective functional can result in a linear system of equations for the update of the unknown expansion coefficient vector in iteration k+1, which may be derived and expressed as Equation 3:

(aₖA+S^{T}(mₖ)S(mₖ)Δmₖ=Sₖ^{T}W_{d}(d−Eₖ(mₖ))−αₖAmₖ (3)

where mₖ₊₁=mₖ+Δmₖ, A represents a regularization matrix, S(mₖ)=W_{d}J(mₖ), and where J(mₖ) represents a Jacobian matrix.

The components of the Jacobian matrix (J(mₖ)) in Equation 3 can be expressed as Equation 4:

$${J}_{ij} ( {m}_{k} ) = \frac{\partial {E}_{i} ( {m}_{k} )}{\partial {c}_{j}^{( k )}} \cdot \frac{\partial {G}^{( k )} ( rj )}{\partial {c}_{j}^{( k )}} = \frac{\partial {E}_{i} ( {m}_{k} )}{\partial {c}_{j}^{( k )}} \cdot {B}_{j} ( {r}_{j} ) \qquad ( 4 )$$

where rⱼ represents a suitable set of spatial points in the sub-surface, i=1 to M, and j=1 to N, where M represents a number of data observations collected from the survey data (which may depend on the amount of data available from a survey over a given area of interest, and on how much of the available data is selected for use, and may thus vary from survey to survey), and where N corresponds to a number of grid points (e.g., defined within the grid as discussed below) that are to be tested in order to achieve a convergent solution.

A discussion of one methodology for selecting a suitable set of spatial points follows. The density of the grid (and thus, the spacing of the grid points represented by intersecting lines in FIG. 2) may vary from one embodiment to the next. Generally speaking, the spacing of the grid points may be any spacing suitable for accurately determining the resistivity within the surveyed/modeled space. The grid itself may include N grid points, where N is an integer value. Describing a three-dimensional grid such grid 200 may be accomplished in terms of a Cartesian coordinate definition. The volume of various embodiments of grid 200 may be confined as follows:

x_min<=x<=x_max,

y_min<=y<=y_max,

z_min<=z<=z_max,

where x_min, x_max, y_min and y_max define the horizontal extent of the grid along their respective axes, while z_min and z_max define the vertical extent of the grid along the z-axis. The minimum and maximum values along the x- and y-axes may be manually determined based on the desired survey area. The minimum and maximum values along the z-axis may be defined at least in part by the depth of the water in which the CSEM survey is to be conducted plus some value beyond to account for, e.g., hydrocarbon deposits. For example, the z-axis upper bound may be chosen at the shallowest point of the sea floor, and the lower bound may be chosen to be several thousand meters below the sea floor (e.g., at a depth expected to be below hydrocarbon deposits). A grid of N points may then be defined according to the following pseudocode:

x_i=x_min+i*dx for i=0 to I, where dx=(x_max−x_min)/(I−1),I=number of points in the x-direction

y_j=y_min+j*dy for j=0 to J, where dy=(y_max−y_min)/(J−1),J=number of points in the y-direction

z_k=z_min+k*dz for k=0 to K, where dz=(z_max−z_min)/(K−1),K=number of points in the z-direction,

and thus, the number of points N in the grid may be defined as:

N=I*J*K.

In one embodiment, selection of the suitable set of spatial points may itself be an iterative process. A number of spatial points I, J, and K may be selected and the inversion conducted with these values (for one non-limiting example, one of every 10 points along each axis). If the results are unsatisfactory (e.g., one indication may be the amount of time elapsed for convergence to occur), the inversion may be conducted again with increased values of I, J, and K. This process may be repeated until the time to convergence is considered acceptable. With a sufficient number of points, convergence may occur relatively quickly. The methodology disclosed herein may allow for convergence to occur with a small number of grid points relative to the overall number of the grid discussed above with reference to FIG. 2. Convergence may be defined in one embodiment by the occurrence of the following condition:

∥Δmₖ∥<0.01∥mₖ∥ (5).

It is noted, however, that convergence may be differently defined in other embodiments depending on factors such as processing resources, input data quality, desired result quality, or other relevant factors.

Returning to Equation 4, the derivative of Eᵢ with respect to Gⱼ can be a Freshét derivative in the Gauss-Newton function. The Freshét derivative is calculated at the sparse set of points rⱼ. Calculating the Freshét derivative at the set of points rⱼ may save a significant amount of computation time and require fewer computing resources as compared to an equivalent calculation for all cells in an ordinary dense inversion grid.

A set of basis functions Bⱼ(r) can, in one embodiment, be a basis spline (b-spline). For instance, an order 5 b-spline may be utilized as the set of basis functions in Equations 1 and 4, although embodiments of the disclosure are not limited to an order 5 b-spline or to b-spline basis functions in general. Collocation may be used to solve Equation 4 with respect to the expansion coefficients, where collocation is a forward modeling method. The collocation points may be equivalent to the discrete points rᵢ. Electromagnetic inversion model reduction, according to the present disclosure, may reduce the number of expansion coefficients for inversion of CSEM data as compared to previous approaches, leading to faster sub-surface resistivity estimation and lower costs.

FIG. 3 is a flow diagram illustrating one embodiment of the inversion discussed above. Method 300 includes the collecting of electric field (EM field) data from a CSEM survey (block 305) and the modeling of the electric field (block 310). It is noted that these two items may be performed in parallel, as shown in FIG. 3. The modeling of the electric field includes defining the electric field over a multi-dimensional grid, such as that exemplified by FIG. 2. The multi-dimensional grid includes a number of grid points, and is based on a resistivity model. The resistivity model includes a set of expansion coefficients that correspond to respective members of a set of orthogonal basis functions. It is the coefficients that are inverted for in the embodiment shown. With regard to the basis functions, various types of orthogonal basis functions may be used, including b-splines, wavelets, curvelets, or a combination thereof.

The method further includes initialization of an objective functional (block 315). An example objective functional is shown above as Equation 2. The initialization of the objective functional is dependent upon both measured electric field data as well as the modeled electric field data. One example of a means for initializing the objective functional includes applying a regularization functional (e.g., R(m) in Equation 2) and a regularization parameter (e.g., α in Equation 2). Following initialization, the objective functional is iteratively minimized to generate an estimated record of a set of expansion coefficients (block 320). Minimization may be accomplished in one embodiment using an iterative Gauss-Newton function, and may result in the linear system of equations as expressed in Equation 3. Iterations further result in the generation of a Jacobian matrix per Equation 4. Each iteration includes performing forward modeling to estimate the modeled electric field dependent on current values of the expansion coefficients, and adjusting the set of expansion coefficients dependent upon a degree to which the estimate of the modeled electric field differs from the measured electric field. Within a given iteration, the minimizing is performed dependent on the Jacobian matrix, which is generated dependent upon the modeled electric field, the current values of the set of expansion coefficients, the orthogonal basis functions, and the selected sparse set of points within the multi-dimensional grid. The generation of the Jacobian matrix may also depend on determination of a Freshét derivative of the modeled electric field with respect to the resistivity model, for example as discussed above with respect to Equation 4. Iterations may continue until one or more convergence criteria are met, such as that shown in Equation 5 above.

Upon completion of the iterative minimization of the objective functional, a multi-dimensional record of resistivity values is generated dependent on the estimated record of expansion coefficients (block 325). This may be accomplished by calculating the resistivity values using the expansion coefficients in, e.g., Equation 1 above. The resistivity values may be recorded on a storage medium, and may be used in an analysis to determine whether hydrocarbon deposits are present in the surveyed space.

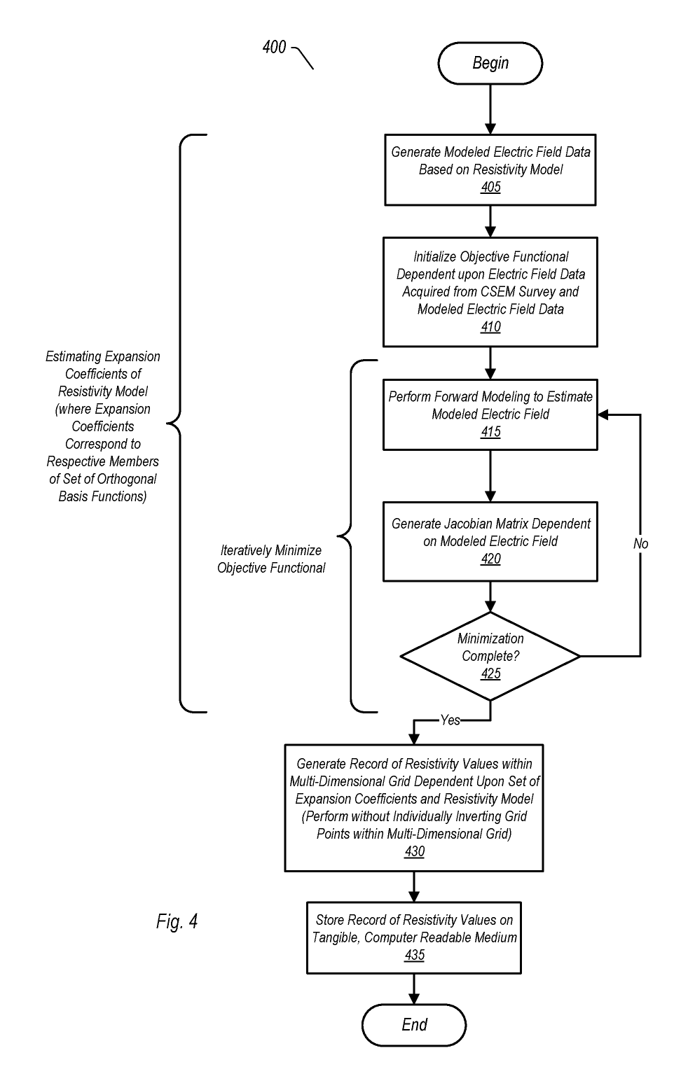

FIG. 4 is a flow diagram illustrating an embodiment of a method for generating and storing a record of resistivity values based on a CSEM survey. Blocks 405 to 425 of method 400 fall within the category of estimating expansion coefficients of a resistivity model. The expansion coefficients, in turn, correspond to respective members of a set of orthogonal basis functions, examples of which were previously discussed. A modeled electric field based on the resistivity model includes a number of grid points in a multi-dimensional grid. However, the number of expansion coefficients is at least one decimal order of magnitude less than the number of grid points. The basis functions may, in one embodiment, correspond to a logarithm of a conductivity expression (where conductivity is the inverse of resistivity). Furthermore, the basis functions can include wavelets, curvelets, b-splines, or any combination thereof (other types of basis functions are also possible and contemplated). Within that group of method blocks, blocks 415 to 425 correspond to an iterative minimization of the objective functional, which results in the record of resistivity values.

Method 400 begins with the generation of modeled electric field data based on a resistivity model (block 405). The modeled electric field is based on a space to be surveyed, such as a volume of ocean subsurface in which hydrocarbon deposits may be present. The model includes a multi-dimensional grid having a number of grid points, with the multi-dimensional grid corresponding to the space to be surveyed. Thereafter, an objective functional is initialized dependent upon electric field data acquired from the CSEM survey and modeled electric field data (block 410).

Following its initialization, the objective functional is iteratively minimized. The minimization (which, in one embodiment, is a Gauss-Newton minimization) includes performing forward modeling to estimate the modeled electric field (block 415). The forward modeling is dependent upon current values of the set of expansion coefficients for the given iteration. Within each iteration, the set of expansion coefficients is adjusted dependent upon a degree to which the modeled electric field differs from the measured electric field. After performing forward modeling within a given iteration, a Jacobian matrix is generated dependent on the modeled electric field (block 420). Generation of the Jacobian matrix within a given iteration is dependent upon current values for the set of expansion coefficients and the set of basis functions. In one embodiment, the Jacobian matrix is generated dependent upon determining a Freshét derivative of the modeled electric field with respect to the resistivity model. It is noted that one example of a means for iteratively minimizing the objective functional includes the forward modeling of block 415, the generation of the Jacobian matrix of block 420, and the convergence test of block 425 described below.

Completion of the minimization is dependent upon meeting convergence criteria. In one embodiment, the one or more convergence criteria depend on the delta between coefficient values in successive iterations of the minimization, e.g., such as expressed above in (5). If the convergence criteria have not been met, and thus the minimization is not complete (block 425, no), the method returns to block 415 and another iteration is performed. If the convergence criteria are met, and thus the minimization is complete (block 425, yes), a record of resistivity values within the multi-dimensional grid is generated (block 430). It is noted that one example of a means for generating the record of resistivity values includes evaluating a conductivity model formulated as a set of basis functions (e.g., as represented by Equation 1) using the set of basis function coefficients identified through minimization of the objective function. An equivalent may employ the use of a resistivity model formulated as a set of basis functions.

The resistivity values are dependent upon the resistivity model and the expansion coefficients that result from convergence of the iterative minimization. It is noted that these resistivity values are obtained without individually inverting each grid point within the multi-dimensional grid, and instead inverting the coefficients. Since the number of coefficients is at least a decimal order of magnitude less than the number of grid points, the time and computing resources required to obtain the resistivity values may be significantly reduced.

The generated record of resistivity values is then stored on a tangible, non-transitory computer readable medium (block 435). This medium may be flash memory, hard disk storage, or any other suitable computer readable storage medium. The resistivity values may be used for, among other purposes, determining the presence of hydrocarbon deposits underneath the body of water in which the CSEM survey was conducted.

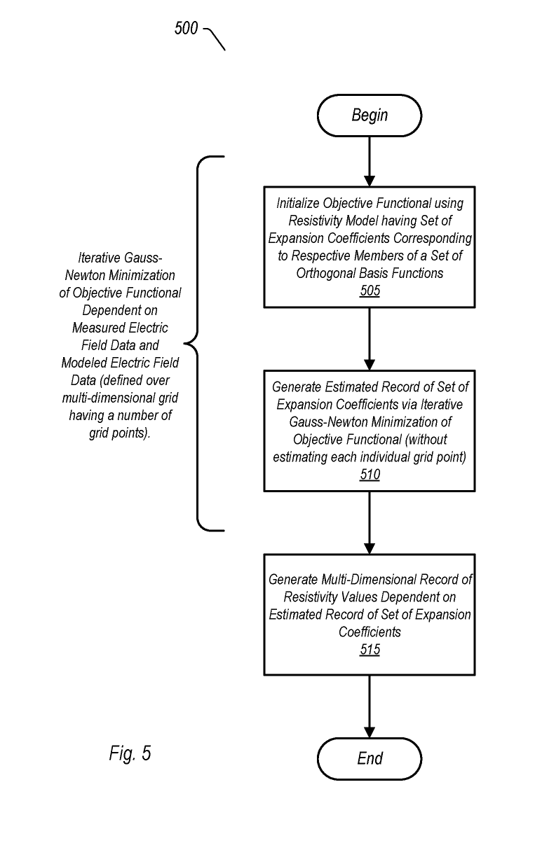

FIG. 5 is a flow diagram illustrating another embodiment of a method for performing an inversion of data collected during a CSEM survey. Blocks 505 and 510 of method 500 fall under the category of performing an iterative Gauss-Newton minimization of an objective functional dependent on electric field data measured during a CSEM survey and modeled electric field data. The modeled electric field data in the embodiment shown is defined over a multi-dimensional grid having a number of grid points.

Method 500 begins with the initialization of an objective functional using a resistivity model having a set of expansion coefficients corresponding to respective members of a set of orthogonal basis functions (block 505). The objective functional and the orthogonal basis functions may be any of the examples discussed above. Following initialization of the objective functional, an estimated record of a set of expansion coefficients is generated (block 510). In the embodiment shown, the set of expansion coefficients is generated via an iterative Gauss-Newton minimization of the objective functional, and without estimating resistivity or conductivity at each individual grid point. Since the number of grid points is at least an order of magnitude greater than the number of coefficients, the generation of the latter may be accomplished using less computer memory and processor time relative to a methodology that is performed for all points in the multi-dimensional grid.

The minimization is complete when convergence occurs, which may be defined by the examples given above. Thereafter, a multi-dimensional record of resistivity values is generated based on the estimated record of the set of expansion coefficients that is obtained from the minimization (block 515). The multi-dimensional record of resistivity values may be stored on a computer readable medium and retrieved for analysis of the electric field generated during the CSEM survey.

In the various method embodiments discussed, solving for coefficients of a conductivity model instead of directly for individual conductivity values can greatly reduce the number of elements that need to be computed. This, in turn, improves the operation of the computer performing the inversion by enabling it to do less work, thereby reducing the time and energy spent on computation. Similarly, the various method embodiments discussed above improve the field of geophysical imaging based on CSEM data by similarly reducing the time, energy, and cost to perform the inversion. In one example of an inversion performed using a methodology as disclosed herein, the number of unknowns was reduced from on the order of millions to approximately 8000—a factor of 100 to 500 in the reduction of the number of unknowns. As a result, the inversion in this example is completed in significantly less time with a correspondingly significant reduction in computing effort.

### Example Computing Devices

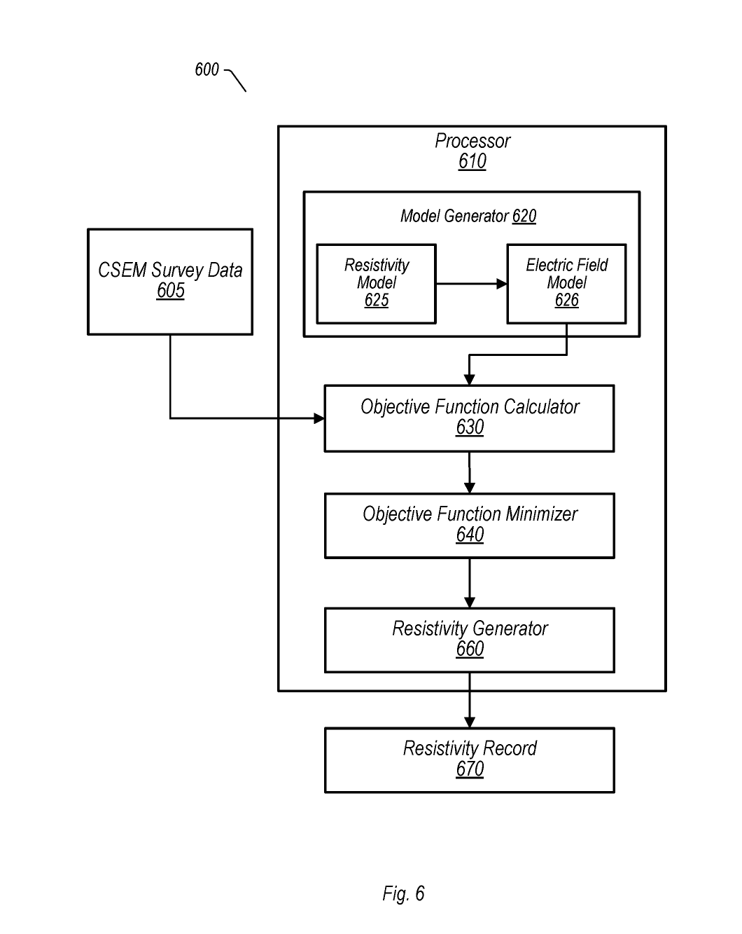

FIG. 6 is a block diagram of one embodiment of a processing apparatus for determining resistivity values based on CSEM survey data. This apparatus may be used in performing the various method embodiments discussed above.

Processing apparatus 600 includes CSEM survey data 605 (which is stored on a non-transitory computer readable medium) and a processor 610. The CSEM survey data 605 may be raw data obtained during the actual performance of the CSEM survey, an example of which is discussed above with reference to FIG. 1. Processor 610 in the embodiment shown includes processing circuitry configured to perform processing functions. In various embodiments, data processor may be a general purpose processor, a graphics processor, a digital signal processor, or any other suitable processing circuitry. The blocks within processor 610 may include firmware, hardware, software, and/or combinations thereof.

Model generator 620 in the embodiment shown includes a resistivity model 625 and an electric field model 626. Data from the resistivity model 625 in the embodiment shown is used to generate the electric field model 626. The electric field model is provided to objective function calculator 630, which generates and initializes an objective functional dependent on CSEM survey data 605 and the electric field model 626 (which incorporates resistivity model 625). Objective function minimizer 640 receives the initialized objective functional and performs a minimization in accordance with the various method embodiments discussed above. Upon completion of the minimization, resistivity generator 660 calculates the resistivity for the points in the grid, based on the set of coefficients produced from the minimization. As noted above, the minimization is performed for the coefficients and a sparse set of points in the grid, which may number in an amount that is at least an order of magnitude less than the total number of grid points. After calculating the resistivity for the grid points, processor 610 outputs the resistivity values to resistivity record 670, which comprises a non-transitory computer readable medium upon which the values are stored for subsequent use in analyzing the electric field.

Referring now to FIG. 7, a block diagram illustrating an embodiment of a device 700 is shown. Device 700 as shown herein is a computer system that may perform the various method embodiments discussed above. In some embodiments, elements of device 700 may be included within a system on a chip. In the illustrated embodiment, device 700 includes interconnect 710, processor 720, input/output (I/O) bridge 750, storage device 752, geophysical data 754, cache/memory controller 745, cache/memory 746, code 748, and graphics/display unit 760.

Interconnect 710 may include various interconnects, buses, MUX's, controllers, etc., and may be configured to facilitate communication between various elements of device 700. In some embodiments, portions of interconnect 710 may be configured to implement various different communication protocols. In other embodiments, interconnect 710 may implement a single communication protocol and elements coupled to interconnect 710 may convert from the single communication protocol to other communication protocols internally.

In the illustrated embodiment, processor 720 includes bus interface unit (BIU) 725, cache 730, and cores 735 and 740. In various embodiments, processor 720 may include various numbers of processors, processor cores and/or caches. For example, processor 720 may include 1, 2, or 4 processor cores, or any other suitable number. In one embodiment, cache 730 is a set associative L2 cache. In some embodiments, cores 735 and/or 740 may include internal instruction and/or data caches. In some embodiments, a coherency unit (not shown) in interconnect 710, cache 730, or elsewhere in device 700 may be configured to maintain coherency between various caches of device 700. BIU 725 may be configured to manage communication between processor 720 and other elements of device 700. Processor cores such as cores 735 and 740 may be configured to execute instructions of a particular instruction set architecture (ISA) which may include operating system instructions and user application instructions.

Cache/memory controller 745 may be configured to manage transfer of data between interconnect 710 and one or more caches and/or memories, including cache/memory 746. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches.

In the illustrated embodiment, cache/memory 746 contains code 748. In some embodiments, code 748 may be used to configure the computing system 700. In other embodiments, code 748 may include instructions for processor 720 to execute, such as instructions relating to the control of any of the systems or devices discussed above, or code 748 may include information directing the usage of I/O Bridge 750. Code 748 may include other information not described here, including but not limited to data, configurations for other components of computing system 700, or instructions to be executed by computing system 700. Code 748 in the embodiment shown includes instructions that, when executed on one or more cores of processor 720, carry out one or more of the various method embodiments for inversion of data obtained from a CSEM survey. Such instructions may include instructions for generating the various models, objective functionals, basis functions, regularization functions, Jacobian matrices, and so forth. Instructions to perform or aid in the analysis of resistivity data for a multi-dimensional grid to determine the presence of, e.g., hydrocarbon deposits within a surveyed space may also be included in code 748, or be associated therewith. Generally speaking, the instructions stored in code 748 may be associated with any one of the method embodiments discussed herein as well as any data to used to make calculated results.

As used herein, the term “coupled to” may indicate one or more connections between elements, and a coupling may include intervening elements. For example, in FIG. 7, graphics unit 760 may be described as “coupled to” a memory through interconnect 710 and cache/memory controller 745. In contrast, in the illustrated embodiment of FIG. 7, graphics unit 760 is “directly coupled” to interconnect 710 because there are no intervening elements.

Graphics/display unit 760 may include one or more processors and/or one or more graphics processing units (GPU's). Graphics/display unit 760 may receive graphics-oriented instructions, such as OPENGL® or DIRECT3D® instructions, for example. Graphics/display unit 760 may execute specialized GPU instructions or perform other operations based on the received graphics-oriented instructions. Graphics/display unit 760 may generally be configured to process large blocks of data in parallel and may build images in a frame buffer for output to a display. Graphics/display unit 760 may include transform, lighting, triangle, and/or rendering engines in one or more graphics processing pipelines. Graphics/display unit 760 may output pixel information for display images.

Graphics/display unit 760 may be configured to read data from a frame buffer and provide a stream of pixel values for display. Graphics/display unit 760 may be configured as a display pipeline in some embodiments. Additionally, Graphics/display unit 760 may be configured to blend multiple frames to produce an output frame. Further, Graphics/display unit 760 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and/or low-power always-on functionality, for example. I/O bridge 750 may also include interfaces such as pulse-width modulation (PWM), general-purpose input/output (GPIO), serial peripheral interface (SPI), and/or inter-integrated circuit (I2C), for example. Various types of peripherals and devices may be coupled to device 700 via I/O bridge 750. In the illustrated embodiment, I/O Bridge 750 is coupled to storage device 752.

In some embodiments, storage device 752 may be a hard disk drive or solid state drive. Storage device 752 may be a tape drive, magnetic drive, removable media drive, etc. in some embodiments. In the illustrated embodiment, storage device 752 includes geophysical data 754.

Geophysical data 754 may include seismic traces, hydrophone recordings, electromagnetic survey data, position data, time data, etc. In some embodiments, geophysical data 754 includes the results from one or more marine seismic surveys. For example, geophysical data may include data obtained from performance of a CSEM survey. Moreover, geophysical data 754 may include resistivity data for a multi-dimensional grid, wherein the resistivity data is produced in accordance with one or more of the various method embodiments discussed above.

In some embodiments, various elements relating to geophysical surveying (e.g., raw data collected by sensors and/or marine survey input data generally, or products derived therefrom by the use of post-collection processing such as the techniques discussed below, to the extent these differ in various embodiments), may be embodied in a “geophysical data product.” A geophysical data product may comprise a computer-readable, non-transitory medium having geophysical data stored on the medium, including, e.g., raw streamer data, processed streamer data, two- or three-dimensional maps based on streamer data, resistivity records, or other suitable representations. Some non-limiting examples of computer-readable media may include tape reels, hard drives, CDs, DVDs, flash memory, print-outs, etc., although any tangible computer-readable medium may be employed to create the geophysical data product. For example, storage device 752 with geophysical data 754 stored thereon is one example of a geophysical data product.

In some embodiments, raw analog data from streamers may be stored in the geophysical data product. In other instances, as noted above, the data may first be digitized and/or conditioned prior to being stored in the geophysical data product. In yet other instances, the data may be fully processed into a two- or three-dimensional map of the various geophysical structures, or another suitable representation, before being stored in the geophysical data product.

The geophysical data product may be manufactured during the course of a survey (e.g., by equipment on a vessel) and then, in some instances, transferred to another location for geophysical analysis, although analysis of the geophysical data product may occur contemporaneously with survey data collection. In other instances, the geophysical data product may be manufactured subsequent to survey completion, e.g., during the course of analysis of the survey. It is noted that any of the methods discussed above may involve the manufacture of a geophysical data product, e.g., via the storage of records of geophysical data on a suitable medium.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory machine-readable medium that stores instructions, wherein the instructions are executable by one or more processors to generate a multi-dimensional record of resistivity values from measured electric field data acquired during a controlled-source electromagnetic (CSEM) survey by performing operations comprising:
initializing an objective functional dependent upon the measured electric field data and modeled electric field data;
wherein the modeled electric field data is defined over a multi-dimensional grid including a plurality of grid points;
wherein the modeled electric field data is generated dependent upon a resistivity model comprising a set of expansion coefficients corresponding to respective members of a set of orthogonal basis functions; and
wherein a number of expansion coefficients in the set of expansion coefficients is at least a decimal order of magnitude smaller than a number of grid points in the plurality of grid points;
generating an estimated record of the set of expansion coefficients by iteratively minimizing the objective functional, wherein generating the estimate of the set of expansion coefficients reduces computational effort compared to estimating individual grid points directly; and
dependent upon the estimated record of the set of expansion coefficients, generating the multi-dimensional record of resistivity values.

2. The non-transitory machine-readable medium of claim 1, wherein the set of orthogonal basis functions includes b-splines, wavelets, curvelets, or a combination thereof.

3. The non-transitory machine-readable medium of claim 1, wherein initializing the objective functional includes applying a regularization functional to the set of expansion coefficients dependent upon a regularization parameter.

4. The non-transitory machine-readable medium of claim 1, wherein iteratively minimizing the objective functional includes performing an iterative Gauss-Newton minimization on the objective functional.

5. The non-transitory machine-readable medium of claim 1, wherein for a given iteration, iteratively minimizing the objective functional includes:
performing forward modeling to estimate the modeled electrical field dependent upon current values for the given iteration of the set of expansion coefficients; and
adjusting the set of expansion coefficients dependent upon a degree to which an estimate of the modeled electrical field differs from the measured electrical field.

6. The non-transitory machine-readable medium of claim 1, wherein for a given iteration, iteratively minimizing the objective functional is performed dependent on a Jacobian matrix generated dependent upon the modeled electrical field, current values for the given iteration of the set of expansion coefficients, and the set of orthogonal basis functions.

7. The non-transitory machine-readable medium of claim 6, wherein the Jacobian matrix is generated dependent upon a sparse set of points within the multi-dimensional grid.

8. The non-transitory machine-readable medium of claim 6, wherein the Jacobian matrix is generated dependent upon determining a Freshét derivative of the modeled electric field with respect to the resistivity model.

9. A method of manufacturing a geophysical data product, comprising:
accessing electric field measurements obtained during performance of a controlled-source electromagnetic (CSEM) survey;
estimating a set of expansion coefficients of a resistivity model, wherein the set of expansion coefficients corresponds to respective members of a set of orthogonal basis functions, wherein estimating the set of expansion coefficients comprises:
initializing an objective functional dependent upon the electric field measurements and upon modeled electric field data, wherein the modeled electric field data is generated dependent upon the resistivity model and is defined over a multi-dimensional grid including a plurality of grid points;
iteratively minimizing the objective functional, wherein a given iteration of the minimizing includes:
performing forward modeling to estimate the modeled electrical field; and
generating a Jacobian matrix dependent upon the modeled electrical field;
generating a record of resistivity values within the multi-dimensional grid dependent upon the set of expansion coefficients and the resistivity model, wherein generating the record of resistivity values is performed without individually inverting grid points within the multi-dimensional grid; and
storing the record of resistivity values on a tangible, computer-readable medium, thereby completing the manufacturing of the geophysical data product.

10. The method of claim 9, wherein a number of expansion coefficients in the set of expansion coefficients is at least a decimal order of magnitude smaller than a number of grid points in the plurality of grid points.

11. The method of claim 9, wherein the basis functions correspond to a logarithm of conductivity in the modeled electric field.

12. The method of claim 9, wherein iteratively minimizing the objective functional includes performing an iterative Gauss-Newton minimization on the objective functional.

13. The method of claim 9, wherein performing forward modeling is dependent upon current values of the set of coefficients for the given iteration, and wherein the method further comprises adjusting the set of expansion coefficients dependent upon a degree to which an estimate of the modeled electrical field differs from the measured electrical field.

14. The method of claim 9, wherein generating the Jacobian matrix is further dependent on current values for the given iteration of the set of expansion coefficients, and the set of orthogonal basis functions, and wherein the Jacobian matrix is generated dependent upon determining a Freshét derivative of the modeled electric field with respect to the resistivity model.

15. The method of claim 9, wherein the set of orthogonal basis functions includes b-splines, wavelets, curvelets, or a combination thereof.

16. In a method of generating a multi-dimensional record of resistivity values from measured electric field data acquired during a controlled-source electromagnetic (CSEM) survey by performing iterative Gauss-Newton minimization of an objective functional dependent upon the measured electric field data and modeled electric field data, wherein the modeled electric field data is defined over a multi-dimensional grid including a plurality of grid points, and wherein individual iterations of the Gauss-Newton minimization include performing forward modeling of the modeled electrical field, the specific improvement comprising:
initializing the objective functional using a resistivity model comprising a set of expansion coefficients corresponding to respective members of a set of orthogonal basis functions;
generating, via the iterative Gauss-Newton minimization of the objective functional, an estimated record of the set of expansion coefficients without estimating each individual grid point within the multi-dimensional grid, thereby reducing a number of computations by at least one decimal order of magnitude; and
dependent upon the estimated record of the set of expansion coefficients and the resistivity model, generating the multi-dimensional record of resistivity values.

17. The method of claim 16, wherein the set of orthogonal basis functions includes b-splines, wavelets, curvelets, or a combination thereof.

18. The method of claim 16, wherein generating the estimated record of the set of expansion coefficients includes, for a given iteration of the iterative Gauss-Newton minimization of the objective functional, generating a Jacobian matrix for a sparse set of points within the multi-dimensional grid, wherein the Jacobian matrix is generated dependent upon the modeled electrical field, current values for the given iteration of the set of expansion coefficients, and the set of orthogonal basis functions.

19. The method of claim 18, wherein the Jacobian matrix is generated dependent upon determining a Freshét derivative of the modeled electric field with respect to the resistivity model.

20. An apparatus for estimating resistivity from measured electric field data acquired during a controlled-source electromagnetic (CSEM) survey using a set of expansion coefficients of a resistivity model, wherein the set of expansion coefficients corresponds to respective members of a set of orthogonal basis functions, comprising:
one or more computer systems having program storage and processing hardware, wherein the processing hardware is operable to execute instructions stored in the program storage to implement:
means for initializing an objective functional dependent upon the measured electric field data and upon modeled electric field data, wherein the modeled electric field data is generated dependent upon the resistivity model and is defined over a multi-dimensional grid including a plurality of grid points;
means for iteratively minimizing the objective functional to generate an estimated record of the set of expansion coefficients dependent upon the measured electric field data; and
means for generating a record of resistivity values within the multi-dimensional grid dependent upon the estimated record of the set of expansion coefficients and the resistivity model, wherein generating the record of resistivity values is performed without individually inverting grid points within the multi-dimensional grid.

21. The apparatus of claim 20, wherein to implement the means for initializing the objective functional, the processing hardware is further operable to execute instructions to implement operations comprising:
applying a regularization functional based on a regularization parameter.

22. The apparatus of claim 20, wherein to implement the means for iteratively minimizing the objective functional for a given iteration of the minimizing, the processing hardware is further operable to execute instructions to implement operations comprising:
performing forward modeling to estimate the modeled electrical field; and
generating a Jacobian matrix dependent upon the modeled electrical field.

23. The apparatus of claim 20, wherein to implement the means for generating the record of resistivity values, the processing hardware is further operable to execute instructions to implement operations comprising:
evaluating the resistivity model at a given grid point dependent upon the estimated record of the set of expansion coefficients.
